(19) United States
(12) Patent Application Publication
(10) Pub. No.: US 2002/0049759 A1
(43) Pub. Date: Apr. 25, 2002

(54) High performance relational database management system

(76) Inventor: Loren Christensen, Manotick (CA)

Correspondence Address: PEARNE & GORDON LLP, 526 SUPERIOR AVENUE EAST, SUITE 1200, CLEVELAND, OH, 44114-1484, US

(21) Appl. No.: 09/842,446

(22) Filed: Apr. 26, 2001

(30) Foreign Application Priority Data
Sep. 18, 2000 (CA) 2,319,918

(51) Int. Cl. G06F 17/30; G06F 15/177

(52) U.S. Cl. 707/10; 709/224

(57) ABSTRACT

A high performance relational database management system, leveraging the functionality of a high speed communications network, comprising at least one performance monitor server computer connected to the network for receiving network management data objects from at least one data collector node device so as to create a distributed database. A histogram routine running on the performance monitoring server computers partitions the distributed database into data hunks. The data hunks are then imported into a plurality of delegated database engine instances running on the performance monitoring server computers so as to parallel process the data hunks. A performance monitor client computer connected to the network is then typically used to access the processed data to monitor object performance.

### FIELD OF THE INVENTION

The present invention relates to the parallel processing of relational databases within a high speed data network, and more particularly to a system for the high performance management of relational databases.

### BACKGROUND OF THE INVENTION

Network management is a large field that is expanding in both users and technology. On UNIX networks, the network manager of choice is the Simple Network Management Protocol (SNMP). This has gained great acceptance and is now spreading rapidly into the field of PC networks. On the Internet, Java-based SNMP applications are becoming readily available.

SNMP consists of a simply composed set of network communication specifications that cover all the basics of network management in a method that can be configured to exert minimal management traffic on an existing network.

The problems seen in high capacity management implementations were only manifested recently with the development of highly scalable versions of relational database management solutions. In the scalability arena, performance degradation becomes apparent when numbers of managed objects reach a few hundreds.

The known difficulties relate either to the lack of a relational database engine and query language in the design, or to memory intensive serial processing in the implementation, specifically access speed scalability limitations, inter-operability problems, custom-designed query interfaces that don't provide the flexibility and ease-of-use that a commercial interface would offer.

Networks are now having to manage ever larger number of network objects as true scalability takes hold, and with vendors developing hardware having ever finer granularity of network objects under management, be they via SNMP or other means, the number of objects being monitored by network management systems is now in the millions. Database sizes are growing at a corresponding rate, leading to increased processing times. As well, the applications that work with the processed data are being called upon to deliver their results in real-time or near-real-time, thereby adding yet another demand on more efficient database methods.

The current trend is towards hundreds of physical devices, which translates to millions of managed objects. A typical example of an object would be a PVC element (VPI/VCI pair on an incoming or outgoing port) on an ATM (Asynchronous Transfer Mode) switch.

The effect of high scalability on the volume of managed objects grew rapidly as industry started increasing the granularity of databases. This uncovered still another problem that typically manifested as processing bottlenecks within the network. As one problem was solved it created another that was previously masked.

In typical management implementations, when scalability processing bottlenecks appear in one area, a plan is developed and implemented to eliminate them, at which point they typically will just “move” down the system to manifest themselves in another area. Each subsequent processing bottleneck is uncovered through performance bench marking measurements once the previous hurdle has been cleared.

The limitations imposed by the lack of parallel database processing operations, and other scalability bottlenecks translates to a limit on the number of managed objects that can be reported on in a timely fashion.

The serial nature of the existing accessors precludes their application in reporting on large managed networks. While some speed and throughput improvements have been demonstrated by modifying existing reporting scripts to fork multiple concurrent instances of a program, the repeated and concurrent raw access to the flat files imposes a fundamental limitation on this approach.

For the foregoing reasons, there exists in the industry a need for an improved relational database management system that provides for high capacity, scalability, backwards compatibility and real-time or near-real-time results.

### SUMMARY OF THE INVENTION

The present invention is directed to a high performance relational database management system that satisfies this need. The system leveraging the functionality of a high speed communications network, comprises receiving collected data objects from at least one data collection node using at least one performance monitoring server computer whereby a distributed database is created.

The distributed database is then partitioned into data hunks using a histogram routine running on at least one performance monitoring server computer. The data hunks are then imported into at least one delegated database engine instance located on at least one performance monitoring server computer so as to parallel process the data hunks whereby processed data is generated. The processed data is then accessed using at least one performance monitoring client computer to monitor data object performance.

The performance monitor server computers are comprised of at least one central processing unit. At least one database engine instance is located on the performance monitor server computers on a ratio of one engine instance to one central processing unit whereby the total number of engine instances is at least two so as to enable the parallel processing of the distributed database.

At least one database engine instance is used to maintain a versioned master vector table. The versioned master vector table generates a histogram routine used to facilitate the partitioning of the distributed database.

This invention addresses the storage and retrieval of very large numbers of collected network performance data, allowing database operations to be applied in parallel to subsections of the working data set using multiple instances of a database by making parallel the above operations, which were previously executed serially. Complex performance reports consisting of data from millions of managed network objects can now be generated in real time. This results in impressive gains in scalability for real-time performance management solutions. Each component has it's own level of scalability.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

These and other features, aspects, and advantages of the present invention will become better understood with regard to the following description, appended claims, and accompanying drawings where:

FIG. 1 is a schematic overview of the high performance relational database management system;

FIG. 2 is a schematic view of the performance monitor server computer and its components; and

FIG. 3 is a schematic overview of the high performance relational database management system.

### DETAILED DESCRIPTION OF THE PRESENTLY PREFERRED EMBODIMENT

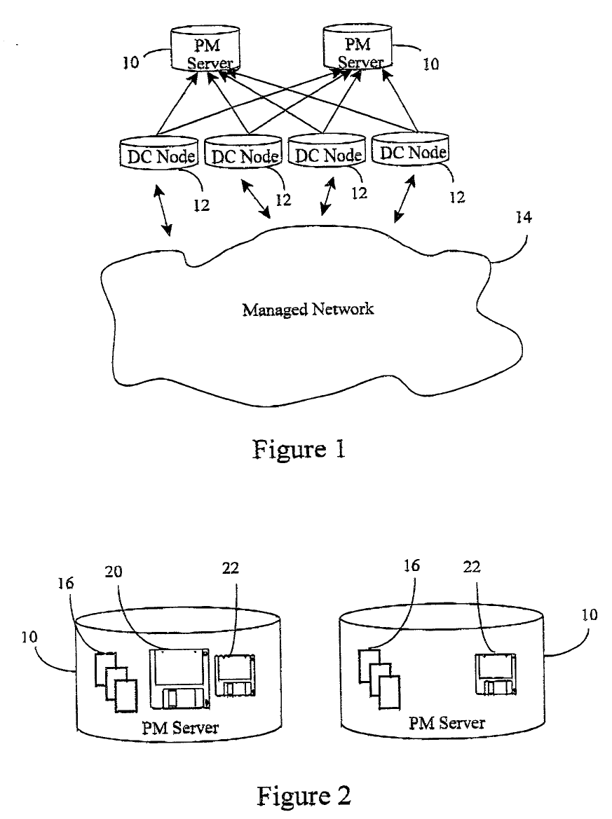

As shown in FIG. 1, the high performance relational database management system, leveraging the functionality of a high speed communication network 14, comprises at least one performance monitor server computer 10 connected to the network 14 for receiving network management data objects from at least one data collection node device 12 so as to create a distributed database 16.

As shown in FIG. 2, a histogram routine 20 running on the performance monitoring server computers 10 partitions the distributed database 16 into data hunks 24. The data hunks 24 are then imported into a plurality of delegated database engine instances 22 running on the performance monitoring server computers 10 so as to parallel process the data hunks 24 whereby processed data 26 is generated.

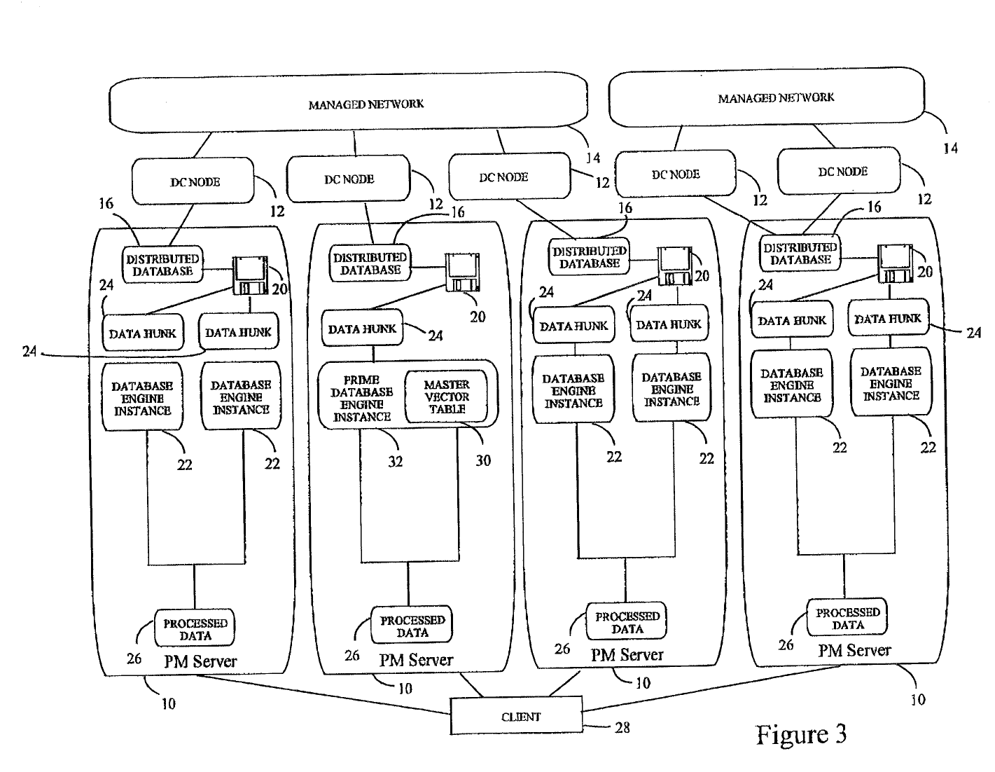

As shown in FIG. 3, at least one performance monitor client computer 28 connected to the network 14 accesses the processed data 26 whereby data object performance is monitored.

At least one database engine instance 22 is used to maintain a versioned master vector table 30. The versioned master vector table 30 generates the histogram routine 20 used to facilitate the partitioning of the distributed database 16. In order to divide the total number on managed objects among the database engines 22, the histogram routine 20 divides indices active at the time of a topology update into the required number of work ranges. Dividing the highest active index by the number of sub-partitions is not an option, since there is no guarantee that retired objects will be linearly distributed throughout the partitions.

The histogram routine 20 comprises dividing the total number of active object identifiers by the desired number of partitions so as to establish the optimum number of objects per partition, generating an n point histogram of desired granularity from the active indices, and summing adjacent histogram routine generated values until a target partition size is reached, but not exceeded. This could be understood as so inherently parallel that it is embarrassing to attack them serially from the active indices.

In order to make the current distribution easily available to all interested processes, a versioned master vector table 30 is created on the prime database engine 32. The topology and data import tasks refer to this table to determine the latest index division information. The table is maintained by the topology import process.

Objects are instantiated in the subservient topological tables by means of a bulk update routine. Most RDBMS's provide a facility for bulk update. This command allows arbitrarily separated and formatted data to be opened and read into a table by the server back end directly. A task is provided, which when invoked, opens up the object table file and reads in each entry sequentially. Each new or redistributed object record is massaged into a format acceptable to an update routine, and the result written to one of n temporary copy files or relations based on the object index ranges in the current histogram. Finally, the task opens a command channel to each back end and issues the copy command and update commands are issued to set “lastseen” times for objects that have either left the system's management sphere, or been locally reallocated to another back end.

The smaller tables are pre-processed in the same way, and are not divided prior to the copy. This ensures that each back end will see these relations identically. In order to distribute the incoming reporting data across the partitioned database engines, a routine is invoked against the most recent flat file data hunk and it's output treated as a streaming data source. The distribution strategy is analogous to that used for the topology data. The data import transforms the route output into a series of lines suitable for the back end's copy routine. The task compares the object index of each performance record against the ranges in the current histogram, and appends it to the respective copy file. A command channel is opened to each back end and the copy command given. For data import, reallocation tracking is automatic since the histogram ranges are always current.

One common paradigm used in distributed-memory parallel computing is data decomposition, or partitioning. This involves dividing the working data set into independent partitions. Identical tasks, running on distinct hardware can then operate on different portions of the data concurrently. Data decomposition is often favored as a first choice by parallel application designers, since the approach minimizes communication and task synchronization overhead during the computational phase. For a very large relational database, partitioning can lead to impressive gains in performance. When certain conditions are met, many common database operations can be applied in parallel to subsections of the data set.

For example, if a table D is partitioned into work units D⁰, D¹, . . . , Dⁿ, then unary operator f is a candidate for parallelism, if and only if

f(D)=f(D₀)Uf(D₁)U . . . f(Dₙ)

Similarly, if a second relation O, is decomposed using the same scheme, then certain binary operators can be invoked in parallel, if and only if

f(D,O)=f(D₀,O₀)Uf(D₁,O₁)U . . . f(Dₙ,Oₙ)

The unary operators projection and selection, and binary operators union, intersection and set difference are unconditionally partitionable. Taken together, these operators are members of a class of problems that can collectively be termed “embarrassingly parallel”. This could be understood as so inherently parallel that it is embarrassing to attack them serially.

Certain operators are amenable to parallelism conditionally. Grouping and Join are in this category. Grouping works as long as partitioning is done by the grouping attribute. Similarly, a join requires that the join attribute also be used for partitioning. That satisfied, tables do not grow symmetrically as the number of total managed objects increases. The object and variable tables soon dwarf the others as more objects are placed under management. For one million managed objects and a thirty minute transport interval, the incoming data to be processed can be on the order of 154 Megabytes in size. A million element object table will be about 0.25 Gigabytes at it's initial creation. This file will also grow over time, as some objects are retired, and new discoveries appear. Considering the operations required in the production of a performance report, it is possible to design a parallel database scheme that will allow a parallel join of distributed sub-components of the data and object tables by using the object identifiers as the partitioning attribute. The smaller attribute, class and variable tables need not be partitioned. In order to make them available for binary operators such as joins, they need only be replicated across the separate database engines. This replication is cheap and easy given the small size of the files in question.

The appearance and retirement of entities in tables is track-ed by two time-stamp attributes, representing the time the entity became known to the system, and the time it departed, respectively. Versioned entities include monitored objects, collection classes and network management variables.

If a timeline contains an arbitrary interval spanning two instants, start and end, an entity can appear or disappear in one of seven possible relative positions. An entity cannot disappear before it becomes known, and it is not permissible for existence to have a zero duration. This means that there are six possible endings for the first start position, five for the second, and so on until the last.

One extra case is required to express an object that both appears and disappears within the subject interval. Therefore, the final count of the total number of cases is determined by the formula:

$$1 + {\sum }_{n = 1}^{6} n$$

There are twenty-two possible entity existence scenarios for any interval with a real duration. Time domain versioning of tables is a salient feature of the design.

A simple and computationally cheap intersection can be used since the domains are equivalent for both selections. Each element of the table need only be processed once, with both conditions applied together.

Application programmers will access the distributed database via an application programming interface (API) providing C, C++, TCL and PERI bindings. Upon initialization the library establishes read-only connections to the partitioned database servers, and queries are executed by broadcasting selection and join criteria to each server. Results returned are aggregated and returned to the application. To minimize memory requirements in large queries, provision is made for returning the results as either an input stream or cache file. This allows applications to process very large data arrays in a flow through manner.

A limited debug and general access user interface is provided in the form of an interactive user interface, familiar to many database users. The monitor handles the multiple connections and uses a simple query rewrite rule system to ensure that returns match the expected behavior of a non-parallel database. To prevent poorly conceived queries from swamping the system's resources, a built-in limit on the maximum number of rows returned is set at monitor startup. Provision is made for increasing the limit during a session.

As the number of total managed objects increases, the corresponding object and variable data tables increase at a non-linear rate. For example, it was found through one test implementation that one million managed objects with a tiny-minute data sample transport interval generated incoming performance management data on the order of 154 Megabytes. A one million element object table will be about 250 Megabytes at it's initial creation. This file will also grow over time as some objects are retired and new discoveries appear.

Considering the operations required in the production of a performance report, it is possible to design a parallel database scheme that will allow a parallel join of distributed sub-components of the data and object tables by using the object identifiers as the partitioning attribute. This involves partitioning data and object tables by index, importing the partitioned network topology data delegated to multiple instances of the database engine, and invoking an application routine against the most recent flat file performance data hunk and directing the output to multiple database engines.

The API and user debug and access interfaces are compliant with standard relational database access methods thereby permitting legacy or in-place implementations to be compatible.

This invention addresses the storage and retrieval of very large numbers of collected network performance data, allowing database operations to be applied in parallel to subsections of the working data set using multiple instances of a database by making parallel the above operations which were previously executed serially. Complex performance reports consisting of data from millions of managed network objects can now be generated in real time. This results in exceptional advancements in scalability for real-time performance management solutions, since each component has it's own level of scalability.

Today's small computers are capable of delivering several tens of millions of operations per second, and continuing increases in power are foreseen. Such computer systems' combined computational power, when interconnected by an appropriate high-speed network, can be applied to solve a variety of computationally intensive applications. In other words network computing, when coupled with prudent application design, can provide supercomputer-level performance. The network-based approach can also be effective in aggregating several similar multiprocessors, resulting in a configuration that might otherwise be economically and technically difficult to achieve, even with prohibitively expensive supercomputer hardware.

With this invention scalability limits are advanced, achieving an unprecedented level of monitoring influence.

What is claimed is:

1. A high performance relational database management system, leveraging the functionality of a high speed communications network, comprising the steps of:
(i) receiving collected data objects from at least one data collection node using at least one performance monitoring computer whereby a distributed database is created;
(ii) partitioning the distributed database into data hunks using a histogram routine running on at least one performance monitoring server computer;
(iii) importing the data hunks into a plurality of delegated database engine instances located on at least one performance monitoring server computer so as to parallel process the data hunks whereby processed data is generated; and
(iv) accessing the processed data using at least one performance client computer to monitor data object performance.

2. The system according to claim 1, wherein at least one database engine instance is located on the performance monitor server computers on a ratio of one engine instance to one central processing unit whereby the total number of engine instances is at least two so as to enable the parallel processing of the distributed database.

3. The system according to claim 2, wherein at least one database engine instance is used to maintain a versioned master vector table.

4. The system according to claim 3, wherein the versioned master vector table generates a histogram routine used to facilitate the partitioning of the distributed database.

5. The system according to claim 4, wherein the histogram routine comprises the steps of:
(i) dividing the total number of active object identifiers by the desired number of partitions so as to establish the optimum number of objects per partition;
(ii) generating an n point histogram of desired granularity from the active indices; and
(iii) summing adjacent histogram routine generated values until a target partition size is reached but not exceeded.

6. The system according to claim 1, wherein the performance monitor server comprises an application programming interface compliant with a standard relational database query language.

7. A high performance relational database management system, leveraging the functionality of a high speed communications network, comprising:
(i) at least one performance monitor server computer connected to the network for receiving network management data objects from at least one data collection node device whereby a distributed database is created;
(ii) a histogram routine running on the performance monitoring server computers for partitioning the distributed database into data hunks;
(iii) at least two database engine instances running on the performance monitoring server computers so as to parallel process the data hunks whereby processed data is generated; and
(iv) at least one performance monitor client computer connected to the network for accessing the processed data whereby data object performance is monitored.

8. The system according to claim 7, wherein at least one database engine instance is located on the performance monitoring server computers on a ratio of one engine instance to one central processing unit whereby the total number of engine instances for the system is at least two so as to enable the parallel processing of the distributed database.

9. The system according to claim 8, wherein at least one database engine instance is used to maintain a versioned master vector table.

10. The system according to claim 9, wherein the versioned master vector table generates a histogram routine used to facilitate the partitioning of the distributed database.

11. The system according to claim 10, wherein the histogram routine comprises the steps of:
(i) dividing the total number of active object identifiers by the desired number of partitions so as to establish the optimum number of objects per partition;
(ii) generating an n point histogram of desired granularity from the active indices; and
(iii) summing adjacent histogram routine generated values until a target partition size is reached but not exceeded.

12. The system according to claim 7, wherein the performance monitor server comprises an application programming interface compliant with a standard relational database query language.

13. The system according to claim 7, wherein at least one performance monitor client computer is connected to the network so as to communicate remotely with the performance monitor server computers.

14. A storage medium readable by an install server computer in a high performance relational database management system including the install server, leveraging the functionality of a high speed communications network, the storage medium encoding a computer process comprising:
(i) a processing portion for receiving collected data objects from at least one data collection node using at least one performance monitoring computer whereby a distributed database is created;
(ii) a processing portion for partitioning the distributed database into data hunks using a histogram routine running on at least one performance monitoring server computer;
(iii) a processing portion for importing the data hunks into a plurality of delegated database engine instances located on at least one performance monitoring server computer so as to parallel process the data hunks whereby processed data is generated; and
(iv) a processing portion for accessing the processed data using at least one performance client computer to monitor data object performance.

15. The system according to claim 14, wherein at least one database engine instance is located on the data processor server computers on a ratio of one engine instance to one central processing unit whereby the total number of engine instances is at least two so as to enable the parallel processing of the distributed database.

16. The system according to claim 15, wherein one of the database engine instances is designated as a prime database engine instance used to maintain a versioned master vector table.

17. The system according to claim 16, wherein the versioned master vector table generates a histogram routine used to facilitate the partitioning of the distributed database.

18. The system according to claim 14, wherein The histogram routine comprises the steps of:
(i) dividing the total number of active object identifiers by the desired number of partitions so as to establish the optimum number of objects per partition;
(ii) generating an n point histogram of desired granularity from the active indices; and
(iii) summing adjacent histogram routine generated values until a target partition size is reached but not exceeded.

19. The system according to claim 14, wherein the performance monitor server comprises an application programming interface compliant with a standard relational database query language.
